(19) United States
(12) Patent Application Publication
(10) Pub. No.: US 2025/0306259 A1
(43) Pub. Date: Oct. 2, 2025

(54) OPTICAL ELEMENT, OPTICAL INSTRUMENT, AND PROJECTOR

(71) Applicant: SEIKO EPSON CORPORATION, Tokyo (JP)

(72) Inventor: Koya SHIRATORI, Matsumoto-shi (JP)

(73) Assignee: SEIKO EPSON CORPORATION, Tokyo (JP)

(21) Appl. No.: 19/094,023

(22) Filed: Mar. 28, 2025

(30) Foreign Application Priority Data
Mar. 29, 2024 (JP) 2024-055571

(51) Int. Cl. G02B 5/30; H04N 9/31

(52) U.S. Cl. CPC G02B 5/3066; H04N 9/3167; H04N 9/3152; H04N 9/3164

(57) ABSTRACT

An optical element includes a light transmissive substrate, a first optical thin film provided on a first surface of the substrate, configured to reflect first light having a first wavelength band out of a visible wavelength band, and configured to transmit infrared light having an infrared wavelength band, and a second optical thin film provided on a second surface and configured to transmit second light having a second wavelength band out of the infrared wavelength band. Transmittance of the first optical thin film for the infrared light incident thereon at an angle of incidence between 30 and 60° is 90% or higher, and out of S- and P-polarized light of the second light, polarized light showing a larger difference between maximum and minimum transmittance when incident on the first optical thin film is defined as first polarized light.

The present application is based on, and claims priority from JP Application Serial Number 2024-055571, filed Mar. 29, 2024, the disclosure of which is hereby incorporated by reference herein in its entirety.

### BACKGROUND

### 1. Technical Field

The present disclosure relates to an optical element, an optical instrument, and a projector.

### 2. Related Art

An optical apparatus such as a projector as a representative example uses an optical element such as a mirror used to coaxially superimpose and combine multiple kinds of colored light emitted from multiple light sources disposed at different positions with each other.

For example, JP-A-2001-042431 discloses a light source apparatus including a light emitting diode (LED) that emits visible light and an LED that emits infrared light, which are disposed at different positions as light sources, and a dichroic mirror that coaxially combines the visible light and the infrared light emitted from the two LEDs with each other. The dichroic mirror of the light source apparatus disclosed in JP-A-2001-042431 transmits infrared light containing near-infrared light, reflects visible light, and emits the visible light and the infrared light so as to travel along an optical path coaxial with the optical path of red light. The visible light and the infrared light emitted from the dichroic mirror are incident on a liquid crystal panel, and at least the visible light is modulated in accordance with image information.

JP-A-2001-042431 is an example of the related art.

In the light source apparatus disclosed in JP-A-2001-042431, however, the visible light and the red light are obliquely incident on the dichroic mirror. The light source apparatus disclosed in JP-A-2001-042431 therefore makes S-polarized light and P-polarized light different in characteristics in each of the visible light and the infrared light emitted from the dichroic mirror. In particular, the transmittance of the dichroic mirror for the infrared light, which passes therethrough, is likely to decrease by a greater amount as the infrared light is incident at a larger angle with respect to the optical axis. In an optical apparatus using multiple types of polarized light containing the S-polarized light and P-polarized light, when the multiple types of polarized light greatly differ in characteristics from each other as described above, an image or an optical pattern to be output has apparent illuminance unevenness. That is, when an optical element is used to superimpose multiple kinds of light emitted from multiple light sources disposed at different positions on each other along coaxial optical paths, there is a need for measures of reducing a difference in optical intensity of the multiple kinds of colored light emitted from the optical element between the polarization directions thereof.

### SUMMARY

An optical element according to an aspect of the present disclosure includes: a light transmissive substrate having a first surface and a second surface opposite the first surface; a first optical thin film provided on the first surface, configured to reflect first light having a first wavelength band out of a visible wavelength band, and configured to transmit infrared light having an infrared wavelength band, and a second optical thin film provided on the second surface and configured to transmit second light having a second wavelength band out of the infrared wavelength band. Transmittance of the first optical thin film for the infrared light incident thereon at an angle of incidence greater than or equal to 30° but smaller than or equal to 60° is 90% or higher. Out of S-polarized light and P-polarized light of the second light, polarized light showing a larger difference between maximum transmittance and minimum transmittance when incident on the first optical thin film at the angle of incidence greater than or equal to 30° but smaller than or equal to 60° is defined as first polarized light, and a positive or negative sign of a gradient of a curve indicating dependence of transmittance of the first optical thin film for first polarized light of the second light is opposite a positive or negative sign of a gradient of a curve indicating dependence of transmittance of the second optical thin film for the first polarized light of the second light.

### BRIEF DESCRIPTION OF THE DRAWINGS

FIG. 1 is a schematic view of a projector according to a first embodiment.

FIG. 2 is a front view of a light transmissive member of the projector shown in FIG. 1.

FIG. 3 is a schematic view of a dichroic mirror that is an optical element of the projector shown in FIG. 1.

FIG. 4 is a graph indicating the dependence of the transmittance of a first optical thin film of the dichroic mirror in FIG. 3 for near-infrared light on the angle of incidence.

FIG. 5 is a graph indicating the dependence of the transmittance of a second optical thin film of the dichroic mirror in FIG. 3 for the near-infrared light on the angle of incidence.

FIG. 6 is a graph indicating the dependence of the transmittance of the dichroic mirror in FIG. 3 for the near-infrared light on the angle of incidence.

FIG. 7 is a graph indicating the dependence of the transmittance of a second optical thin film of the dichroic mirror in Comparative Example for the near-infrared light on the angle of incidence.

FIG. 8 is a graph indicating the dependence of the transmittance of the dichroic mirror in Comparative Example for the near-infrared light on the angle of incidence.

FIG. 9 is a schematic view of a projector according to a second embodiment.

FIG. 10 is a schematic view of a projector according to a third embodiment.

### DESCRIPTION OF EMBODIMENTS

Embodiments of the present disclosure will be described below with reference to the drawings. In the drawings, elements are each drawn at different dimensional scales in some cases for clarity of the element.

### First Embodiment

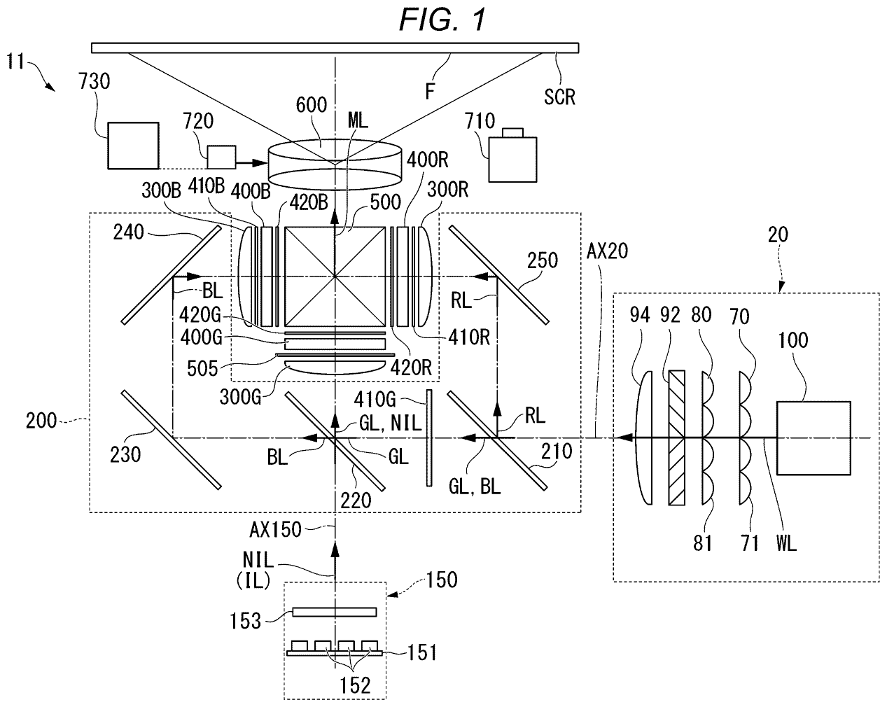

A first embodiment of the present disclosure will be described with reference to FIGS. 1 to 8. FIG. 1 is a schematic view showing the configuration of a projector 11 according to the first embodiment of the present disclosure. The projector 11 is an optical instrument and an image display apparatus including three liquid crystal panels as light modulators, and the projector 11 is what is called a three-plate projector.

### Projector

The projector 11 includes an illuminator 20, a light source apparatus 150, a color separation system 200, field lenses 300R, 300G, and 300B, light-incident-side polarizers 410R, 410G, and 410B, light modulators 400R, 400G, and 400B, light-exiting-side polarizers 420R, 420G, and 420B, a light transmissive member 505, a cross dichroic prism 500, a projection system 600, an imager 710, a moving mechanism 720, and a controller 730, as shown in FIG. 1.

The illuminator 20 includes a light source apparatus 100, a first lens array 70, a second lens array 80, a polarization converter 92, and a superimposing lens 94. The illuminator 20 emits white light WL.

The light source apparatus 100 emits the white light WL. The detailed configuration of the light source apparatus 100 is not limited to a specific configuration as long as the light source apparatus 100 can emit the white light WL. The light source apparatus 100 may include, for example, an LED or a laser diode (LD) that emits blue light, and a phosphor that is excited by part of the blue light emitted from the LED or the LD and emits yellow light as fluorescence.

The white light WL emitted from the light source apparatus 100 is parallelized and enters the first lens array 70. The first lens array 70 includes multiple lenslets 71, which divide the white light WL emitted from the light source apparatus 100 into multiple sub-luminous fluxes. The multiple lenslets 71 are arranged in a matrix in a plane perpendicular to an optical axis AX20 of the light source apparatus 100.

The second lens array 80 includes multiple lenslets 81 corresponding to the multiple lenslets 71 of the first lens array 70. The multiple lenslets 81 are arranged in a matrix in a plane perpendicular to the optical axis AX20. The second lens array 80 along with the superimposing lens 94 forms images of the lenslets 71 of the first lens array 70 in the vicinity of an image formation region of each of the light modulators 400R, 400G, and 400B.

The polarization converter 92 includes polarization separating layers, reflection layers, and phase retarders, none of which is shown. The polarization converter 92 converts the sub-luminous fluxes emitted from the second lens array 80 into linearly polarized light. The polarization converter 92 is formed in the shape of a plate as a whole. The plate surfaces of the polarization converter 92 are disposed in parallel to the plane perpendicular to the optical axis AX20.

The polarization separating layers of the polarization converter 92 transmit one linearly polarized component out of polarized components contained in the sub-luminous fluxes emitted from the second lens array 80, and reflect the other linearly polarized component in a direction perpendicular to the optical axis AX20. The reflection layers of the polarization converter 92 reflect the other linear polarized component reflected off the polarization separating layers in the direction parallel to the optical axis AX20. The phase retarders of the polarization converter 92 convert the other linearly polarized component reflected the off reflection layers into the one linearly polarized component.

The superimposing lens 94 collects the sub-luminous fluxes from the polarization converter 92 and superimposes the collected sub-luminous fluxes on one another in the vicinity of the image formation region of each of the light modulators 400R, 400G, and 400B. The first lens array 70, the second lens array 80, and the superimposing lens 94 constitute an optical integration system. The optical integration system homogenizes the in-plane optical intensity distribution of the white light WL to be emitted from the Illuminator 20 in the image formation region of each of the light modulators 400R, 400G, and 400B.

The color separation system 200 includes dichroic mirrors 210 and 220 and reflection mirrors 230, 240, and 250. The dichroic mirror 220 corresponds to an optical element. The color separation system 200 separates the white light WL emitted from the illuminator 20 into red light RL, green light GL, and blue light BL, which are visible light, and guides the red light RL, the green light GL, and the blue light BL to the light modulators 400R, 400G, and 400B, respectively. Furthermore, infrared light IL from the light source apparatus 150 is incident on the dichroic mirror 220 of the color separation system 200.

The dichroic mirror 210 transmits the green light GL and the blue light BL and reflects the red light RL out of the incident white light WL. The dichroic mirror 220 transmits the blue light BL out of the incident green light GL and blue light BL, reflects the green light GL, and transmits the incident infrared light IL. The configuration of the dichroic mirror 220 will be described later. The reflection mirrors 230 and 240 reflect the incident blue light BL. The reflection mirror 250 reflects the incident red light RL.

The field lenses 300R, 300G, and 300B are disposed between the color separation system 200 and the respective light modulators 400R, 400G, and 400B in the respective optical paths of the red light RL, the green light GL, and the blue light BL. The red light RL reflected off the reflection mirror 250 passes through the field lens 300R and is incident on the image formation region of the light modulator 400R. The green light GL reflected off the dichroic mirror 220 passes through the field lens 300G and is incident on the image formation region of the light modulator 400G. The blue light BL reflected off the reflection mirror 240 passes through the field lens 300B and is incident on the image formation region of the light modulator 400B.

A relay lens that is not shown may be disposed in the optical path of the blue light BL between the dichroic mirror 220 and the reflection mirror 230, and between the reflection mirrors 230 and 240. The thus disposed relay lenses reduce the loss of the blue light BL traveling along a longer optical path length than the green light GL and the red light RL.

The light source apparatus 150 includes a substrate 151, multiple light emitters 152, and a homogenizer 153. The substrate 151 is, for example, a plate-shaped member made of metal. The multiple light emitters 152 are disposed at a plate surface of the substrate 151 that faces the dichroic mirror 220 of the color separation system 200. The light emitters 152 each emit the infrared light IL. The wavelength of the infrared light IL is, for example, longer than or equal to 930 nm but shorter than or equal to 950 nm, and belongs to the near-infrared wavelength band. Note that the light source apparatus 150 may instead include only one light emitter 152. The light emitters 152 may each, for example, be an LED that emits the infrared light IL.

The homogenizer 153 is disposed in the optical path of the infrared light IL emitted from the multiple light emitters 152 between the multiple light emitters 152 and the dichroic mirror 220. The homogenizer 153 homogenizes the optical intensity distribution of the infrared light IL emitted from the multiple light emitters 152 in a plane perpendicular to an optical axis AX150 of the infrared light IL. The homogenizer 153 is, for example, a light collecting lens including at least one convex lens, a holographic optical element (HOE) formed by a computer-generated hologram (CGH), or a diffractive optical element (DOE).

The light-incident-side polarizer 410R is disposed in the optical path of the red light RL between the field lens 300R and the light modulator 400R. The light-incident-side polarizer 410R transmits S-polarized light of the incident red light RL, and reflects or absorbs P-polarized light of the red light RL. The light-incident-side polarizer 410G is disposed in the optical path of the green light GL between the dichroic mirrors 210 and 220 and at a position off the optical path of the infrared light IL. The light-incident-side polarizer 410G transmits the S-polarized light of the incident green light GL, and reflects or absorbs the P-polarized light of the green light GL. The light-incident-side polarizer 410G is, for example, an inorganic polarizer. The light-incident-side polarizer 410B is disposed in the optical path of the blue light BL between the field lens 300B and the light modulator 400B. The light-incident-side polarizer 410B transmits the S-polarized light of the incident blue light BL, and reflects or absorbs the P-polarized light of the blue light BL.

The light modulators 400R, 400G, and 400B modulate the incident red light RL, green light GL, and blue light BL in accordance with image information to form image light. The light modulators 400R, 400G, and 400B are each configured, for example, with a liquid crystal panel. The operation mode of the liquid crystal panel may be any one of a TN mode, a VA mode, a lateral electric field mode, and the like, and is not limited to a specific mode.

The light-exiting-side polarizer 420R is disposed in the optical path of the red image light between the light modulator 400R and the cross dichroic prism 500. The light-exiting-side polarizer 420R transmits the P-polarized light of the incident red image light, and reflects or absorbs the S-polarized light image light. The light-exiting-side polarizer 420G is disposed in the optical path of the green image light and the infrared light IL between the light modulator 400G and the cross dichroic prism 500. The light-exiting-side polarizer 420G transmits the P-polarized light of the incident green image light and infrared light IL, and reflects or absorbs the S-polarized light of the green image light and the infrared light IL. The light-exiting-side polarizer 420G is, for example, an organic polarizer. The light-exiting-side polarizer 420B is disposed in the optical path of the blue image light between the light modulator 400B and the cross dichroic prism 500. The light-exiting-side polarizer 420B transmits the P-polarized light of the incident blue image light, and reflects or absorbs the S-polarized light of the blue image light.

The light transmissive member 505 is disposed in the optical path of the green light GL between the light-incident-side polarizer 410G and the light modulator 400G.

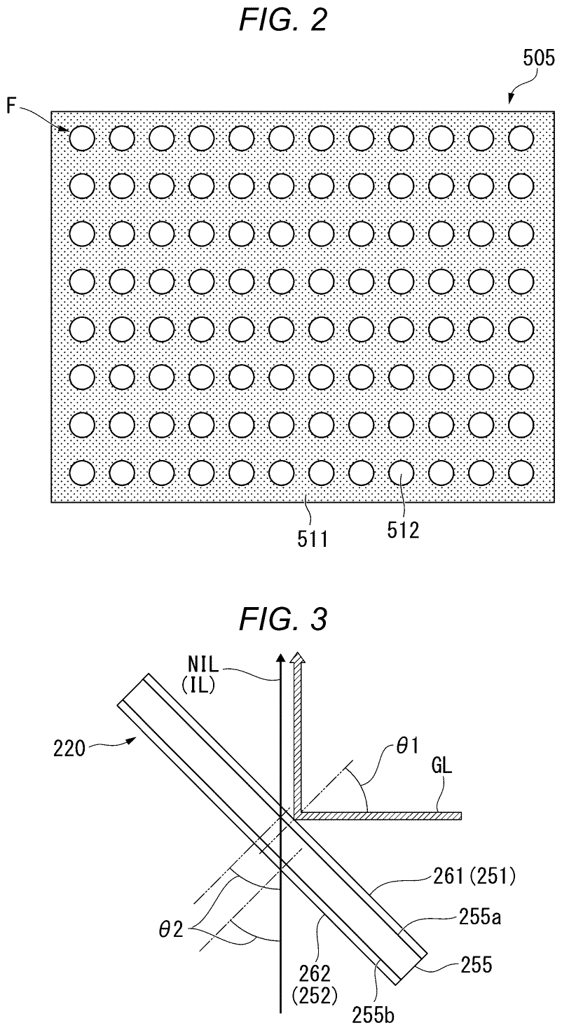

FIG. 2 is a front view of the light transmissive member 505 viewed along the direction in which the green light GL and the infrared light IL enter the light transmissive member 505. The light transmissive member 505 includes a light blocking section 511 and light transmitting sections 512. The light blocking section 511 blocks the infrared light IL by reflecting or absorbing the infrared light IL, and transmits the green light GL. The light transmitting sections 512 transmit both the infrared light IL and light having a visible wavelength band and containing the green light GL, that is, visible light. The light transmitting sections 512 are disposed in a predetermined pattern F. The predetermined pattern F of the light transmitting sections 512 is, for example, a dot pattern. The infrared light IL passing through the light transmissive member 505 and emit therefrom contains the predetermined dot pattern F. The visible light passing through the light transmissive member 505 and emit therefrom is not blocked by the light blocking section 511 and does not contain the predetermined pattern F.

The cross dichroic prism 500 combines the image light emitted from the light modulator 400R, the image light emitted from the light modulator 400G, and the image light emitted from the light modulator 400B with one another to generate color image light ML, and emits the patterned infrared light IL, as shown in FIG. 1. The cross dichroic prism 500 is formed in a substantially cubic shape as a whole by arranging four rectangular prisms in such a way that the apexes thereof coincide with a common center position in the plan view, as shown in FIG. 1. In the cross dichroic prism 500, dichroic mirrors configured, for example, with dielectric multilayer films that are not shown are formed at the interfaces where the rectangular prisms are bonded to each other.

The image light ML and the patterned infrared light IL emitted from the cross dichroic prism 500 are enlarged and projected onto a screen SCR by the projection system 600.

The imager 710 captures an image of the patterned infrared light IL projected by the projection system 600. The imager 710 is, for example, an imaging camera, and is disposed at any location in the projector 11 where the imager 710 does not block the light emitted from the projection system 600. The imager 710 is, for example, a near-infrared camera device. The infrared light IL preferably has a wavelength band containing wavelengths longer than or equal to 930 nm but shorter than or equal to 950 nm. Using the infrared light having the wavelengths longer than or equal to 930 nm but shorter than or equal to 950 nm, which is low-energy sunlight, can suppress a decrease in the contrast of the patterned infrared light IL due to the sunlight when the screen SCR is irradiated with the infrared light IL. As a result, the imager 710 can favorably capture an image of the patterned infrared light IL.

The moving mechanism 720 receives an electric signal from the controller 730, and adjusts the position of the projection system 600 as appropriate to change the positions of the projection image and the patterned infrared light IL on the screen SCR.

The controller 730 controls the moving mechanism 720 and the light modulators 400R, 400G, and 400B in accordance with the image captured by the imager 710. The controller 730 changes the region where an image is formed in an image display region of the light modulator 400R corresponding to the red light RL in accordance with the image captured by the imager 710.

The controller 730 is configured, for example, with a computer or an integrated circuit in which processes carried out by drivers that drive the imager 710, the moving mechanism 720, the light source apparatus 150, and the light modulators 400R, 400G, and 400B are recorded in the form of a program. The controller 730 is, for example, a processor. The controller 730 is electrically coupled to the drive circuits, which drive the imager 710, the moving mechanism 720, the light source apparatus 150, and the light modulators 400R, 400G, and 400B, via wires that are not shown or wirelessly.

### Dichroic Mirror (Optical Element)

FIG. 3 is a schematic view of the dichroic mirror 220. The dichroic mirror 220 includes a light transmissive substrate 255 and optical thin films 251 and 252, as shown in FIG. 3. The optical thin film 251 corresponds to a first optical thin film. The optical thin film 252 corresponds to a second optical thin film.

The light transmissive substrate 255 is a base of the dichroic mirror 220, is a thin-plate-shaped member, and has plate surfaces 255a and 255b. The light transmissive substrate 255 is made of a material that transmits at least the green light GL and the infrared light IL, and is made, for example, of optical glass or quartz. The plate surface 255a of the light transmissive substrate 255 corresponds to a first surface, faces the field lens 300G, and inclines at approximately 45° with respect to the light incident surface of the light modulator 400G. The plate surface 255b of the light transmissive substrate 255 corresponds to a second surface, faces the reflection mirror 230, and is substantially parallel to the reflection surface of the reflection mirror 230.

The optical thin film 251 is provided on the plate surface 255a of the light transmissive substrate 255. The optical thin film 251 is provided as a reflection film of the dichroic mirror 220, reflects the green light GL having a green wavelength band out of the visible wavelength band, and transmits near-infrared light NIL having the near-infrared wavelength band out of the infrared wavelength band. The optical thin film 252 is provided on the plate surface 255b of the light transmissive substrate 255. The optical thin film 252 is provided as an antireflection film of the dichroic mirror 220, transmits light containing the red light RL having the visible wavelength band, and transmits the near-infrared light NIL having the near-infrared wavelength band. The green wavelength band corresponds to a first wavelength band. The near-infrared wavelength band corresponds to a second wavelength band and ranges, for example, from 920 nm to 960 nm. The green light GL corresponds to first light. The near-infrared light NIL corresponds to second light.

The green light GL incident on the dichroic mirror 220 is incident on the optical thin film 251 at an angle of incidence θ1 of approximately 45° and is reflected off the optical thin film 251. The blue light BL, which is not shown, incident on the dichroic mirror 220 along the optical path coaxial with the optical path of the green light GL is incident on the optical thin film 251 at the angle of incidence θ1 of approximately 45°, and sequentially passes through the optical thin film 251, the light transmissive substrate 255, and the optical thin film 252. The near-infrared light NIL incident on the dichroic mirror 220 along the optical path perpendicular to the optical path of the green light GL is incident on the optical thin film 252 at an angle of incidence θ2 of approximately 45°, and sequentially passes through the optical thin film 252, the light transmissive substrate 255, and the optical thin film 251.

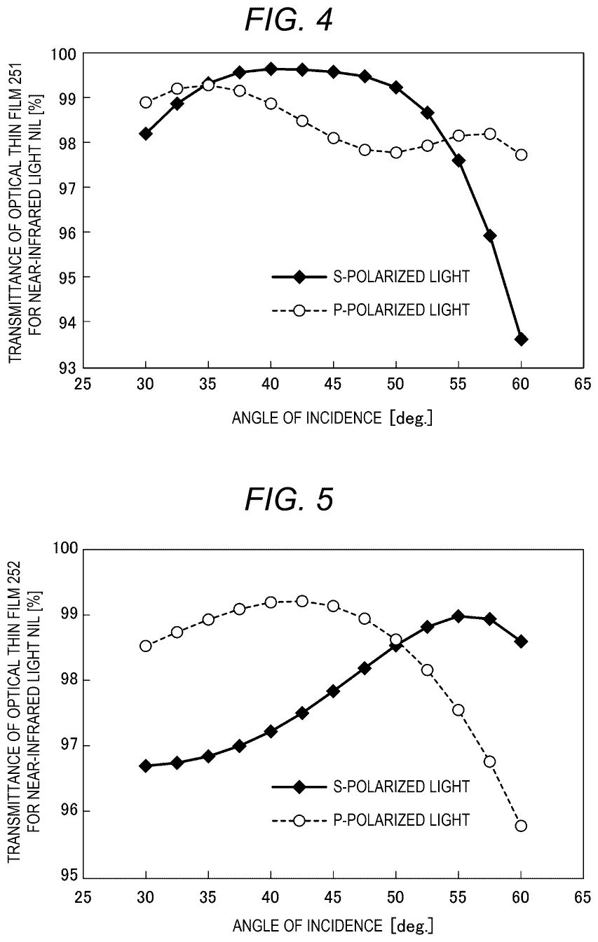

FIG. 4 shows graphs of the transmittance of the optical thin film 251 for the near-infrared light NIL, which specifically show the dependence of the transmittance of the optical thin film 251 for the near-infrared light NIL incident thereon on the angle of incidence θ2. The transmittance shown along the vertical axis of each of FIG. 4 and FIGS. 5 to 8 to be referred to later is average transmittance for the near-infrared light NIL having the wavelength band ranging from 920 nm to 960 nm. The average transmittance is calculated by (sum of transmittance values at 1-nm intervals)/(number of points where transmittance is measured), and the number of the points is 41.

In the range of the angle of incidence θ2 greater than or equal to 30° but smaller than or equal to 60°, the maximum transmittance of the optical thin film 251 for the S-polarized light of the near-infrared light NIL is 99.6%, and the minimum transmittance of the optical thin film 251 for the S-polarized light of the near-infrared light NIL is 93.6%, as shown in FIG. 4. The difference between the maximum transmittance and the minimum transmittance of the optical thin film 251 for the S-polarized light of the near-infrared light NIL is 6.0%.

The transmittance of the optical thin film 251 for the S-polarized light of the near-infrared light NIL nonlinearly increases as the angle of incidence θ2 increases from 30° to around 40°, reaches the maximum transmittance when the angle of incidence θ2 is 40°, and nonlinearly decreases as the angle of incidence θ2 further increases from 40° to 60°. In the range of the angle of incidence θ2 greater than or equal to 30° but smaller than or equal to 60°, the gradient of the curve indicating the dependence of the transmittance of the optical thin film 251 for the S-polarized light of the near-infrared light NIL on the angle of incidence is positive over the range of the angle of incidence θ2 from 30° to around 40° and negative over the range of the angle of incidence θ2 from around 40° to 60°. The gradient of the curve indicating the dependence of the transmittance on the angle of incidence is the gradient of the tangent of the curve passing through the transmittance at each angle of incidence.

Similarly, in the range of the angle of incidence θ2 greater than or equal to 30° but smaller than or equal to 60°, the maximum transmittance of the optical thin film 251 for the P-polarized light of the near-infrared light NIL is 99.3%, and the minimum transmittance of the optical thin film 251 for the P-polarized light of the near-infrared light NIL is 97.8%. The difference between the maximum transmittance and the minimum transmittance of the optical thin film 251 for the P-polarized light of the near-infrared light NIL is 1.5%, which is smaller than the difference between the maximum transmittance and the minimum transmittance of the optical thin film 251 for the S-polarized light of the near-infrared light NIL. The S-polarized light corresponds to “first polarized light” described in the appended claims.

The transmittance of the optical thin film 251 for the S-polarized light of the near-infrared light NIL nonlinearly increases as the angle of incidence θ2 increases from 30° to around 35°, reaches the maximum transmittance at the angle of incidence θ2 of 35°, temporarily nonlinearly decreases as the angle of incidence θ2 increases from 35° to around 50°, nonlinearly increases again as the angle of incidence θ2 increases from 50° to 57.5°, and nonlinearly decreases as the angle of incidence θ2 further increases from 57.5° to 60°.

FIG. 5 shows graphs of the transmittance of the optical thin film 252 for the near-infrared light NIL, which specifically show the dependence of the transmittance of the optical thin film 252 for the near-infrared light NIL incident thereon on the angle of incidence θ2. The transmittance of the optical thin film 252 for the S-polarized light of the near-infrared light NIL nonlinearly increases as the angle of incidence θ2 increases from 30° to around 55°, reaches 99.0%, which is the maximum transmittance, when the angle of incidence 02 is 55°, and nonlinearly decreases as the angle of incidence θ2 further increases from 55° to 60°, as shown in FIG. 5. In most of the range of the angle of incidence θ2 greater than or equal to 30° but smaller than or equal to 60°, that is, in the range of the angle of incidence θ2 greater than or equal to 30° but smaller than or equal to 55°, the gradient of the curve indicating the dependence of the transmittance of the optical thin film 252 for the S-polarized light of the near-infrared light NIL on the angle of incidence is positive. In the range of the angle of incidence θ2 greater than or equal to around 55° but smaller than or equal to 60°, the gradient of the curve indicating the dependence of the transmittance of the optical thin film 252 for the S-polarized light of the near-infrared light NIL on the angle of incidence is negative.

In the range of the angle of incidence θ2 greater than or equal to 30° but smaller than or equal to 60°, the transmittance of the optical thin film 252 for the P-polarized light of the near-infrared light NIL nonlinearly increases as the angle of incidence θ2 increases from 30° to around 42.5°, reaches 99.2%, which is the maximum transmittance, when the angle of incidence θ2 is 42.5°, and nonlinearly decreases as the angle of incidence θ2 further increases from 42.5° to 60°.

The dichroic mirror 220 has a range of the angle of incidence over which the positive or negative sign of the gradient of the curve indicating the dependence of the transmittance of the optical thin film 251 for the S-polarized light of the near-infrared light NIL on the angle of incidence 02 is opposite the positive or negative sign of the gradient of the curve indicating the dependence of the transmittance of the optical thin film 252 for the S-polarized light of the near-infrared light NIL on the angle of incidence θ2. This means that the structure of the optical thin film 252 is so designed that a change in the transmittance of the optical thin film 252 for the S-polarized light of the near-infrared light NIL tends to be opposite a change in the transmittance of the optical thin film 251 for the S-polarized light of the near-infrared light NIL within the range of the angle of incidence θ2 from 30° to 60°, particularly within the range of the angle of incidence θ2 from at least 30° to 55°.

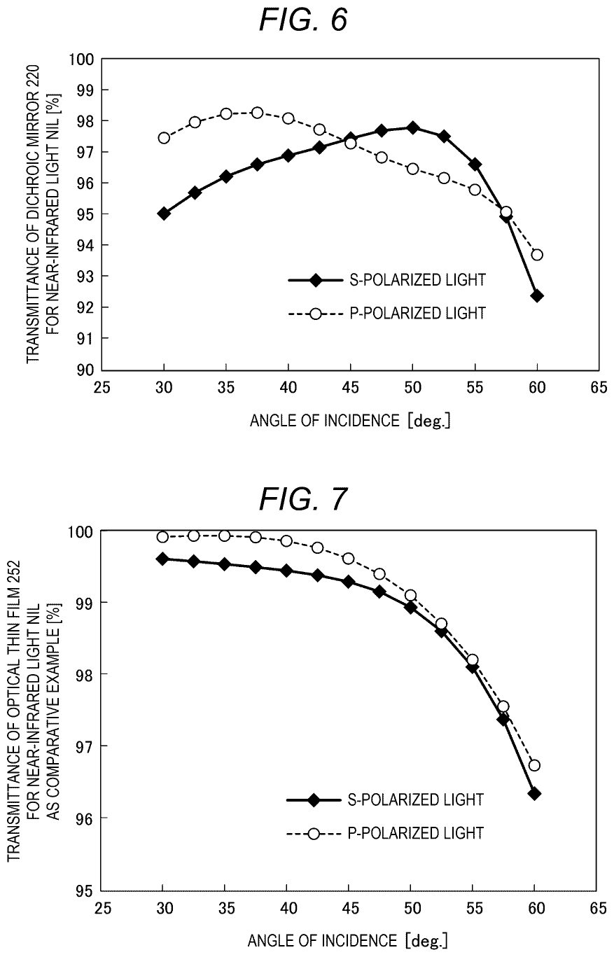

FIG. 6 shows graphs of the transmittance of the entire dichroic mirror 220 for the near-infrared light NIL, which specifically show the dependence of the transmittance of a composite film configured with the optical thin films 251 and 252 for the near-infrared light NIL on the angle of incidence θ2. The maximum transmittance of the entire dichroic mirror 220 for the S-polarized light of the near-infrared light NIL is 97.8%, and the minimum transmittance of the entire dichroic mirror 220 for the S-polarized light of the near-infrared light NIL is 92.4%, as shown in FIG. 6. The difference between the maximum transmittance and the minimum transmittance of the entire dichroic mirror 220 for the S-polarized light of the near-infrared light NIL is 5.4%.

Comparative Example will be described with reference to FIG. 7. In Comparative Example, the polarization is not so adjusted that a change in the transmittance of the optical thin film 252 for the S-polarized light of the near-infrared light NIL is opposite a change in the transmittance of the optical thin film 251 for the S-polarized light of the near-infrared light NIL within the range of the angle of incidence θ2 from at least 30° to 55°, unlike the present embodiment.

FIG. 7 shows graphs of the transmittance of the optical thin film 252 for the near-infrared light NIL as Comparative Example. In Comparative Example, the transmittance of the optical thin film 252 for the S-polarized light of the near-infrared light NIL is 99.6%, which is the maximum transmittance, when the angle of incidence θ2 is 30°, nonlinearly decreases as the angle of incidence θ2 increases from 30° to around 60°, and becomes 96.3%, which is the minimum transmittance, when the angle of incidence θ2 is 60°, as shown in FIG. 7. In the range of the angle of incidence θ2 greater than or equal to 30° but smaller than or equal to 60°, the gradient of the curve indicating the dependence of the transmittance of the optical thin film 252 for the S-polarized light of the near-infrared light NIL on the angle of incidence is negative, which is the same as the gradient of the curve indicating the dependence of the transmittance of the optical thin film 251 for the S-polarized light of the near-infrared light NIL on the angle of incidence.

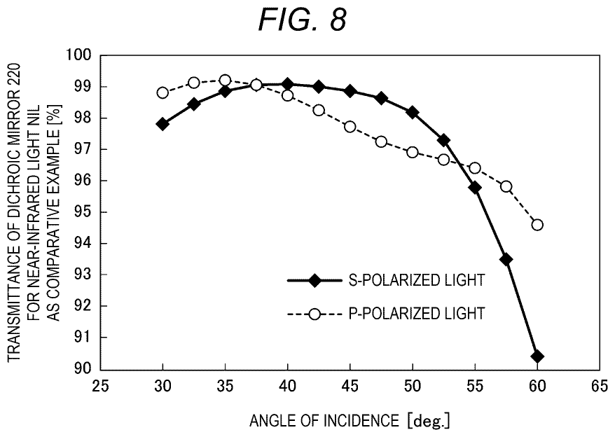

FIG. 8 shows graphs of the transmittance of the entire dichroic mirror 220 for the near-infrared light NIL as Comparative Example. The maximum transmittance of the entire dichroic mirror 220 for the S-polarized light of the near-infrared light NIL as Comparative Example is improved to 98.7%, but the minimum transmittance of the entire dichroic mirror 220 for the S-polarized light of the near-infrared light NIL decreases to 90.4%, as shown in FIG. 8. The difference between the maximum transmittance and the minimum transmittance of the entire dichroic mirror 220 for the S-polarized light of the near-infrared light NIL as Comparative Example increases to 8.3%.

In the dichroic mirror 220 in the present embodiment, the optical thin film 251 is configured with a dielectric multilayer film 261. The dielectric multilayer film 261 has a layered structure in which first high-refractive-index layers that are not shown and first low-refractive-index layers that are not shown but have a refractive index lower than that of first the high-refractive-index layers are alternately layered on each other in the thickness direction. The material of the first high-refractive-index layers is, for example, tantalum pentoxide (Ta₂O₅). The material of the first low-refractive-index layers is, for example, silicon dioxide (SiO₂). The difference in refractive index between Ta₂O₅ and SiO₂ at a wavelength of 530 nm of the green light GL is 0.7.

The material of the first high-refractive-index layers and the material of the first low-refractive-index layers may be changed as appropriate as long as the difference in refractive index between the first high-refractive-index layers and the first low-refractive-index layers is appropriate, and each preferably include any one of an oxide, a nitride, and a fluoride. When the material of the first high-refractive-index layers or the material of the first low-refractive-index layers contains an oxide, the absorption of the green light GL, the blue light BL, and the near-infrared light NIL is suppressed over a range from the visible wavelength band to the near-infrared wavelength band, for example, a range from 200 nm to 1000 nm. Therefore, even when the number of the first high-refractive-index layers and the number of the first low-refractive-index layers increase, a decrease in the reliability of the dielectric multilayer film 261 and the optical thin film 251 and an increase in the manufacturing cost are suppressed.

When the material of the first high-refractive-index layers or the material of the first low-refractive-index layers contains a nitride, the hardness of the first high-refractive-index layers and the first low-refractive-index layers is ensured, and a decrease in the reliability of the dielectric multilayer film 261 and the optical thin film 251 and a defect due to aging or external impact are suppressed. When the material of the first high-refractive-index layers or the material of the first low-refractive-index layers contains a fluoride, the absorption of the green light GL, the blue light BL, and the near-infrared light NIL is suppressed over a wider wavelength band than in the case where one of the two materials contains an oxide. Therefore, even when the number of first high-refractive-index layers and the number of first low-refractive-index layers increase, the decrease in the reliability of the dielectric multilayer film 261 and the optical thin film 251 and the increase in the manufacturing cost are further suppressed.

The number of the first high-refractive-index layers, the number of the first low-refractive-index layers, and the difference in refractive index between the first high-refractive-index layers and the first low-refractive-index layers in the dielectric multilayer film 261 are determined in accordance with the dependence of the transmittance of the optical thin film 251 for at least the S-polarized light of the green light GL on the angle of incidence θ1, specifically so determined that the reflectance of the optical thin film 251 for the S-polarized light of the green light GL incident thereon is high when the angle of incidence θ1 is 45° and the transmittance of the optical thin film 251 for the S-polarized light of the blue light BL incident thereon is high when the angle of incidence θ1 is 45°. Table 1 shows an example of the design of the first high-refractive-index layers and the first low-refractive-index layers of the dielectric multilayer film 261.

TABLE 1

| Layer number | Material | Thickness [nm] |
|---|---|---|
| 1 | SiO₂ | 152.2 |
| 2 | Ta₂O₅ | 94.3 |
| 3 | SiO₂ | 52.0 |
| 4 | Ta₂O₅ | 88.0 |
| 5 | SiO₂ | 105.2 |
| 6 | Ta₂O₅ | 85.5 |
| 7 | SiO₂ | 48.1 |
| 8 | Ta₂O₅ | 93.1 |
| 9 | SiO₂ | 52.2 |
| 10 | Ta₂O₅ | 92.7 |
| 11 | SiO₂ | 52.2 |
| 12 | Ta₂O₅ | 92.7 |
| 13 | SiO₂ | 52.2 |
| 14 | Ta₂O₅ | 92.7 |
| 15 | SiO₂ | 52.2 |
| 16 | Ta₂O₅ | 92.7 |
| 17 | SiO₂ | 52.2 |
| 18 | Ta₂O₅ | 92.7 |
| 19 | SiO₂ | 52.2 |
| 20 | Ta₂O₅ | 92.7 |
| 21 | SiO₂ | 52.2 |
| 22 | Ta₂O₅ | 92.7 |
| 23 | SiO₂ | 52.2 |
| 24 | Ta₂O₅ | 92.7 |
| 25 | SiO₂ | 52.2 |
| 26 | Ta₂O₅ | 92.7 |
| 27 | SiO₂ | 52.2 |
| 28 | Ta₂O₅ | 92.7 |
| 29 | SiO₂ | 52.2 |
| 30 | Ta₂O₅ | 92.7 |
| 31 | SiO₂ | 52.2 |
| 32 | Ta₂O₅ | 92.9 |
| 33 | SiO₂ | 51.3 |
| 34 | Ta₂O₅ | 88.8 |
| 35 | SiO₂ | 89.0 |
| 36 | Ta₂O₅ | 87.5 |
| 37 | SiO₂ | 98.8 |
| 38 | Ta₂O₅ | 14.9 |
| 39 | SiO₂ | 111.1 |

Note that the layer number in Table 1 means the number of each layer counted from the side close to the plate surface 255a of the light transmissive substrate 255. The thickness in Table 1 is the thickness of each layer in the direction perpendicular to the plate surface 255a.

In the dichroic mirror 220 in the present embodiment, the optical thin film 251 is preferably a color separation filter.

In the dichroic mirror 220 in the present embodiment, the optical thin film 252 is configured with a dielectric multilayer film 262. The dielectric multilayer film 262 a has layered structure in which second high-refractive-index layers that are not shown and second low-refractive-index layers that are not shown but have a refractive index lower than that of the second high-refractive-index layers are alternately layered on each other in the thickness direction. The material of the second high-refractive-index layers is, for example, tantalum pentoxide (Ta₂O₅), as that of the first high-refractive-index layers. The material of the second low-refractive-index layers is, for example, silicon dioxide (SiO₂), as that of the first low-refractive-index layer. The difference in refractive index between Ta₂O₅ and SiO₂ at a wavelength of 940 nm of the near-infrared light NIL is 0.65.

The material of the second high-refractive-index layers and the material of the second low-refractive-index layers may be changed as appropriate as long as the difference in refractive index between the second high-refractive-index layers and the second low-refractive-index layers is appropriate, and each preferably include any one of an oxide, a nitride, and a fluoride for the same reason for the material of the first high-refractive-index layers and the material of the first low-refractive-index layers.

The number of the second high-refractive-index layers, the number of the second low-refractive-index layers, and the difference in refractive index between the second high-refractive-index layers and the second low-refractive-index layers in the dielectric multilayer film 262 are determined in accordance with the dependence of the transmittance of the optical thin film 251 for at least the S-polarized light of the green light GL on the angle of incidence θ1 as described above. Specifically, the aforementioned parameters for the dielectric multilayer film 262 are each so set that the positive or negative sign of the gradient of the curve indicating the dependence of the transmittance of the dielectric multilayer film 262, which forms the optical thin film 252, for the S-polarized light of the near-infrared light NIL on the angle of incidence θ2 is opposite the positive or negative sign of the gradient of the curve indicating the dependence of the transmittance of the dielectric multilayer film 261, which forms the optical thin film 251, for the S-polarized light of the near-infrared light NIL on the angle of incidence θ2 so that the dependence of the transmittance of the dielectric multilayer film 261 for the S-polarized light of the near-infrared light NIL on the angle of incidence θ2 is adjusted by the dependence of the transmittance of the dielectric multilayer film 262 for the S-polarized light of the near-infrared light NIL on the angle of incidence θ2. Table 2 shows an example of the design of the second high-refractive-index layers and the second low-refractive-index layers of the dielectric multilayer film 262.

TABLE 2

| Layer number | Material | Thickness [nm] |
|---|---|---|
| 1 | SiO₂ | 224.7 |
| 2 | Ta₂O₅ | 12.5 |
| 3 | SiO₂ | 87.6 |
| 4 | Ta₂O₅ | 14.1 |
| 5 | SiO₂ | 79.0 |
| 6 | Ta₂O₅ | 128.6 |
| 7 | SiO₂ | 13.7 |
| 8 | Ta₂O₅ | 97.4 |
| 9 | SiO₂ | 143.2 |
| 10 | Ta₂O₅ | 26.7 |
| 11 | SiO₂ | 24.0 |
| 12 | Ta₂O₅ | 42.2 |
| 13 | SiO₂ | 89.4 |
| 14 | Ta₂O₅ | 22.1 |
| 15 | SiO₂ | 123.3 |

Note that the layer number in Table 2 means the number of each layer counted from the side close to the plate surface 255b of the light transmissive substrate 255. The thickness in Table 2 is the thickness of each layer in the direction perpendicular to the plate surface 255b.

The dichroic mirror (optical element) 220 in the first embodiment includes the light transmissive substrate 255, the optical thin film (first optical thin film) 251, and the optical thin film (second optical thin film) 252, as described above. The light transmissive substrate 255 has the plate surface (first surface) 255a, and the plate surface (second surface) 255b opposite the plate surface 255a. The optical thin film 251 is provided on the plate surface 255a of the light transmissive substrate 255, reflects the green light GL (first light) having the green wavelength band (first wavelength band) out of the visible wavelength band, and transmits the near-infrared light NIL, which is infrared light. The optical thin film 252 is provided on the plate surface 255b of the light transmissive substrate 255, transmits the near-infrared light (second light) NIL having the near-infrared wavelength band (second wavelength band) out of the infrared wavelength band, and transmits light having the visible wavelength band. In the dichroic mirror 220 in the first embodiment, the transmittance of the optical thin film 251 for the near-infrared light (infrared light) NIL incident at the angle of incidence θ2 greater than or equal to 30° but smaller than or equal to 60° is 90% or higher. In the dichroic mirror 220 in the first embodiment, out of the S-polarized light and the P-polarized light of the near-infrared light NIL, the S-polarized light (first polarized light) is, for example, polarized light showing a larger difference between the maximum transmittance and the minimum transmittance when incident on the optical thin film 251 at the angle of incidence θ2 greater than or equal to 30° but smaller than or equal to 60°. In the dichroic mirror 220 in the first embodiment, the gradient of the curve indicating the dependence of the transmittance of the optical thin film 251 for the S-polarized light of the near-infrared light NIL on the angle of incidence is negative when the angle of incidence θ2 ranges from around 40° to around 55°. The gradient of the curve indicating the dependence of the transmittance of the optical thin film 252 for the S-polarized light of the near-infrared light NIL on the angle of incidence is positive when the angle of incidence ranges from around 30° to around 55°, which is opposite the gradient of the curve indicating the dependence of the transmittance of the optical thin film 251 for the S-polarized light of the near-infrared light NIL on the angle of incidence. The dichroic mirror 220 in the first embodiment has a range of the angle of incidence θ2 over which the gradient of the curve indicating the dependence of the transmittance of the optical thin film 251 for the S-polarized light of the near-infrared light NIL on the angle of incidence is opposite the gradient of the curve indicating the dependence of the transmittance of the optical thin film 252 for the S-polarized light of the near-infrared light NIL on the angle of incidence. The range is, for example, from 40° to 55° and includes 45°.

The dichroic mirror 220 in the first embodiment has a range of the angle of incidence over which the positive or negative sign of the gradient of the curve indicating the dependence of the transmittance of the optical thin film 251 for the S-polarized light of the near-infrared light NIL on the angle of incidence is opposite the positive or negative sign of the gradient of the curve indicating the dependence of the transmittance of the optical thin film 252 for the S-polarized light of the near-infrared light NIL on the angle of incidence as described above, so that the polarization adjustment is performed on the optical thin film 252. The dichroic mirror 220 in the first embodiment can suppress the amount of a change due to the dependence of the optical intensity of the S-polarized light of the near-infrared light NIL emitted from the dichroic mirror 220 on the angle of incidence θ2, and can reduce the difference in the optical intensity of the near-infrared light NIL and the difference in the polarization characteristics of the near-infrared light NIL between the polarization directions thereof. As a result, the illuminance unevenness of the optical pattern of the near-infrared light NIL projected onto the screen SCR can be reduced.

In the dichroic mirror 220 in the first embodiment, the optical thin film 251 transmits the blue light (third light) BL having a blue wavelength band (third wavelength band) out of the visible wavelength band, which differs from the green wavelength band. The optical thin film 252 transmits the blue light BL.

The dichroic mirror 220 in the first embodiment can separate the incident green light GL and blue light BL from each other so as to travel in different directions, and emit the incident near-infrared light NIL along an optical path coaxial with that of the green light GL to combine the green light GL and the near-infrared light NIL with each other.

In the dichroic mirror 220 in the first embodiment, the optical thin film 251 is configured with the dielectric multilayer film (first dielectric multilayer film) 261, in which the first high-refractive-index layers and the first low-refractive-index layers are alternately layered on each other. The optical thin film 252 is configured with the dielectric multilayer film (second dielectric multilayer film) 262, in which the second high-refractive-index layers and the second low-refractive-index layers are alternately layered on each other.

The dielectric multilayer films absorb the colored light only by a small amount, and the controllability and design flexibility of the dielectric multilayer films are higher than those of other optical thin films. The dichroic mirror 220 in the first embodiment can reduce the difference in the optical intensity of the near-infrared light NIL between the polarization directions thereof, that is, the difference in the optical intensity between the S-polarized light and the P-polarized light of the near-infrared light NIL, and the difference in the polarization characteristics including the dependence of the near-infrared light NIL on the angle of incidence θ2 while minimizing a decrease in the efficiency of the green light GL and the near-infrared light NIL.

In the dichroic mirror 220 in the first embodiment, the number of the first high-refractive-index layers, the number of the first low-refractive-index layers, and the difference in the refractive index between the first high-refractive-index layers and the first low-refractive-index layers in the dielectric multilayer film 261 are determined in accordance with the dependence of the transmittance of the optical thin film 251 for the S-polarized light of the green light GL on the angle of incidence. In the dichroic mirror 220 in the first embodiment, the number of the second high-refractive-index layers, the number of the second low-refractive-index layers, and the difference in the refractive index between the second high-refractive-index layers and the second low-refractive-index layers in the dielectric multilayer film 262 are determined in accordance with the positive or negative sign of the gradient of the curve indicating the dependence of the transmittance of the optical thin film 251 for the S-polarized light of the near-infrared light NIL on the angle of incidence.

The dichroic mirror 220 in the first embodiment can readily reduce the difference in the optical intensity of the near-infrared light NIL between the polarization directions thereof, and the difference in the polarization characteristics including the dependence of the near-infrared light NIL on the angle of incidence θ2 while minimizing the decrease in the efficiency of the green light GL and the near-infrared light NIL.

In the dichroic mirror 220 in the first embodiment, the dielectric multilayer films 261 and 262 each include any of an oxide, a nitride, and a fluoride.

The dichroic mirror 220 in the first embodiment can suppress absorption or loss of the green light GL and the near-infrared light NIL in the optical thin films 251 and 252, deterioration of the optical thin films 251 and 252, or the like.

In the dichroic mirror 220 in the first embodiment, the second wavelength band is the near-infrared wavelength band.

The dichroic mirror 220 in the first embodiment, which involves the near-infrared wavelength band containing wavelengths longer than those in the visible wavelength band, allows widening the range over which the material of each of the high-refractive-index and low-refractive-index layers of the optical thin films 251 and 252 or the dielectric multilayer films 261 and 262 is selected, so that the layers can be readily manufactured. Furthermore, since the second wavelength band is adjacent to and close to the first wavelength band, the dichroic mirror 220 in the first embodiment can reduce the influence on the amount of each of the multiple types of colored light passing through and the amount of each of the multiple types of colored light reflected off the light transmissive substrate 255, as a representative example, and each of the other optical elements disposed in the optical paths of the green light GL, the blue light BL, and the near-infrared light NIL.

In the dichroic mirror 220 in the first embodiment, the transmittance of the optical thin film 252 for the S-polarized light out of the S-polarized light and the P-polarized light (at least one of two types of polarized light) of the near-infrared light NIL increases as the angle of incidence θ2 of the S-polarized light increases.

The dichroic mirror 220 in the first embodiment can suppress a decrease in the efficiency of the colored light in the projector 11 and other optical instruments including the dichroic mirror 220.

In the dichroic mirror 220 in the first embodiment, the first wavelength band is the green wavelength band, and the third wavelength band is the blue wavelength band. The dichroic mirror 220 separates the incident green light GL and blue light BL from each other so as to travel along different optical paths.

The projector (optical instrument) 11 according to the first embodiment includes the dichroic mirror 220 described above. In the projector 11 according to the first embodiment, it is preferable that the near-infrared light NIL is incident on the optical thin film 252 in such a way that the intensity of the S-polarized light of the near-infrared light NIL emitted from the optical thin film 252 and the intensity of the P-polarized light thereof are substantially equal to each other.

In the projector 11 according to the first embodiment, the difference in the polarization characteristics between the green light and the near-infrared light NIL emitted from the dichroic mirror 220 is reduced. The projector 11 according to the first embodiment can prevent apparent illuminance unevenness in an image enlarged and projected onto the screen SCR and the optical pattern of the near-infrared light NIL.

In the projector 11 according to the first embodiment, the angle of incidence θ1 of the green light GL incident on the dichroic mirror 220 and the angle of incidence θ2 of the near-infrared light NIL incident thereon are each 45°. Note that the angle of incidence θ1 is the angle of the green light GL incident on the optical thin film 251 of the dichroic mirror 220 with respect to a normal to the plate surface 255a of the light transmissive substrate 255. The angle of incidence θ2 is the angle of the near-infrared light NIL incident on the optical thin films 251 and 252 of the dichroic mirror 220 with respect to a normal to the plate surface 255b of the light transmissive substrate 255.

The projector 11 according to the first embodiment allows the arrangement of the elements of the color separation system 200 to be simplified and the elements to be readily designed.

In the projector 11 according to the first embodiment, the near-infrared light NIL emitted from the light emitters 152 of the light source apparatus 150 is randomly polarized light.

In the projector 11 according to the first embodiment, LEDs can be used as the light emitters 152, so that the size and cost of the projector 11 can be reduced.

In the projector 11 according to the first embodiment, the green light GL may be linearly polarized light incident as the S-polarized light on the optical thin film 251 of the dichroic mirror 220. In this case, when the green light GL is reflected off the optical thin film 251 of the dichroic mirror 220, the S-polarized light of the green light GL can be more intense than the P-polarized light of the green light GL.

The projector 11 according to the first embodiment further includes the light modulator 400G. The green light (light) GL and the near-infrared light (light) NIL emitted from the dichroic mirror 220 enter the light modulator 400G. The light modulator 400G modulates the green light GL having the visible wavelength band out of the incident green light GL and near-infrared light NIL in accordance with image information to convert the green light GL into image light.

The projector 11 according to the first embodiment can provide the green image light generated by the light modulator 400G and the patterned near-infrared light NIL generated by the light transmissive member 505 and the like without being modulated by the light modulator 400G.

### Second Embodiment

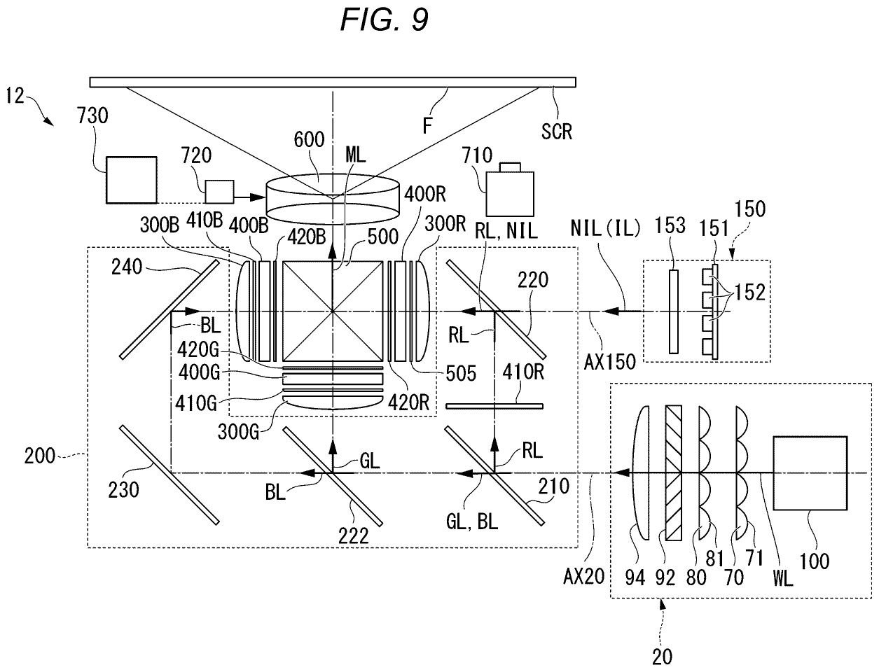

A second embodiment of the present disclosure will next be described with reference to FIG. 9. Note in the second embodiment and a third embodiment that configurations common to those in the first embodiment have the same reference characters as those of the corresponding configurations in the first embodiment, and no descriptions redundant to those in the first embodiment will be made. In the second and third embodiments, configurations and contents different from those in the first embodiment will be described.

FIG. 9 is a schematic view showing the configuration of a projector 12 according to the second embodiment. The projector 12 according to the second embodiment is similar to the projector 11 according to the first embodiment, as shown in FIG. 9. In the projector 12 according to the second embodiment, however, a dichroic mirror 222, which reflects the incident green light GL and transmits the incident blue light BL, is disposed in place of the dichroic mirror 220 in the projector 11 according to the first embodiment. Furthermore, the dichroic mirror 220 is disposed in place of the reflection mirror 250. The light-incident-side polarizer 410R is moved to a position on the optical path of the red light RL between the dichroic mirrors 210 and 220. The light transmissive member 505 is disposed in the optical path of the red light RL between the field lens 300R and the light modulator 400R.

In the projector 12 according to the second embodiment, the dichroic mirror 220 reflects the incident red light RL and transmits the incident infrared light IL. In the projector 12 according to the second embodiment, the green light GL can be replaced with the red light RL in the description of the configuration of the dichroic mirror 220. In the projector 12 according to the second embodiment, the configurations common to those of the dichroic mirror 220 and the projector 11 according to the first embodiment can provide the same effects and advantages.

### Third Embodiment

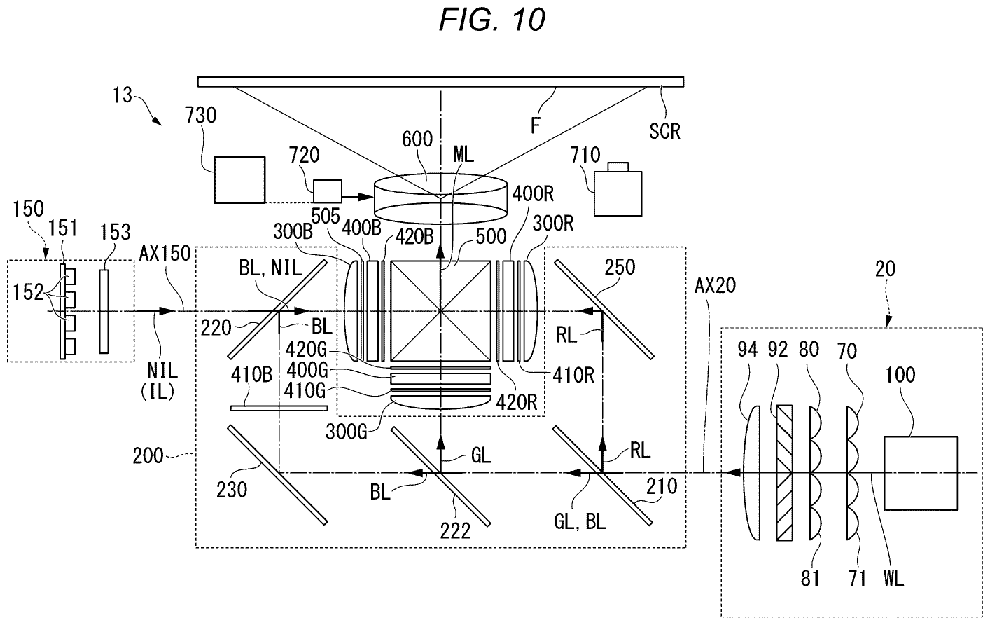

A third embodiment of the present disclosure will next be described with reference to FIG. 10.

FIG. 10 is a schematic view showing the configuration of a projector 13 according to the third embodiment. The projector 13 according to the third embodiment is similar to the projector 11 according to the first embodiment, as shown in FIG. 10. In the projector 13 according to the third embodiment, however, the dichroic mirror 222, which reflects the incident green light GL and transmits the incident blue light BL, is disposed in place of the dichroic mirror 220 in the projector 11 according to the first embodiment. Furthermore, the dichroic mirror 220 is disposed in place of the reflection mirror 240, and the portion involving the dichroic mirror 220 is moved leftward. The light-incident-side polarizer 410B is moved to a position on the optical path of the blue light BL between the reflection mirror 230 and the dichroic mirror 220. The light transmissive member 505 is disposed in the optical path of the blue light BL between the field lens 300B and the light modulator 400B.

In the projector 13 according to the third embodiment, the dichroic mirror 220 reflects the incident blue light BL and transmits the incident infrared light IL. In the projector 13 according to the third embodiment, the green light GL may be replaced with the blue light BL in the description of the configuration of the dichroic mirror 220. In the projector 13 according to the third embodiment, the configurations common to those of the dichroic mirror 220 and the projector 11 according to the first embodiment can provide the same effects and advantages.

Preferable embodiments of the present disclosure have been described above in detail. The present disclosure is, however, not limited to a specific embodiment, and various modifications and changes can be made to the preferable embodiments within the scope of the gist of the present disclosure described in the claims.

For example, a projector is presented by way of example as the optical instrument in the above description, but the optical instrument to which the present disclosure is applied is not limited to a projector. The optical instrument to which the present disclosure is applied may, for example, be a head-mounted display apparatus or an output apparatus such as a printer.

### Summary of Present Disclosure

The present disclosure will be summarized below as additional remarks.

(Additional Remark 1) An optical element including: a light transmissive substrate having a first surface and a second surface opposite the first surface; a first optical thin film provided onthe first surface, configured to reflect first light having a first wavelength band out of a visible wavelength band, and configured to transmit infrared light having an infrared wavelength band; and a second optical thin film provided on the second surface and configured to transmit second light having a second wavelength band out of the infrared wavelength band, wherein transmittance of the first optical thin film for the infrared light incident thereon at an angle of incidence greater than or equal to 30° but smaller than or equal to 60° is 90% or higher, and out of S-polarized light and P-polarized light of the second light, polarized light showing a larger difference between maximum transmittance and minimum transmittance when incident on the first optical thin film at the angle of incidence greater than or equal to 30° but smaller than or equal to 60° is defined as first polarized light, and a positive or negative sign of a gradient of a curve indicating dependence of transmittance of the first optical thin film for first polarized light of the second light is opposite a positive or negative sign of a gradient of a curve indicating dependence of transmittance of the second optical thin film for the first polarized light of the second light.

The configuration described in Additional Remark 1 can reduce a difference in optical intensity between the S-polarized light and the P-polarized light of the second light emitted from the optical element and having the infrared wavelength band.

(Additional Remark 2) The optical element according to Additional Remark 1, wherein the first optical thin film is configured to transmit third light having a third wavelength band out of the visible wavelength band that differs from the first wavelength band, and the second optical thin film is configured to transmit the third light.

The configuration described in Additional Remark 2 can separate the first light and the third light from each other so as to travel in different directions and along different optical paths, and superimpose the optical path of the second light on an optical path coaxial with that of the first light to combine the first light and the second light with each other.

(Additional Remark 3) The optical element according to Additional Remark 1 or 2, wherein the first optical thin film is configured with a first dielectric multilayer film in which first high-refractive-index layers and first low-refractive-index layers are alternately layered on each other, and the second optical thin film is configured with a second dielectric multilayer in film which second high-refractive-index layers and second low-refractive-index layers are alternately layered on each other.

According to the configuration described in Additional Remark 3, absorption and loss of the first light and the second light in the optical element can be suppressed, and a decrease in efficiency of the first light and the second light can be prevented.

(Additional Remark 4) The optical element according to Additional Remark 3, wherein the number of the first high-refractive-index layers, the number of the first low-refractive-index layers, and a difference in refractive index between the first high-refractive-index layers and the first low-refractive-index layers are determined in accordance with the dependence of the transmittance of the first optical thin film for the first polarized light of the first light on the angle of incidence, and the number of the second high-refractive-index layers, the number of the second low-refractive-index layers, and a difference in refractive index between the second high-refractive-index layers and the second low-refractive-index layers are determined in accordance with the positive or negative sign of the gradient of the curve indicating the dependence of the transmittance of the first optical thin film for the first polarized light of the second light on the angle of incidence.

According to the configuration described in Additional Remark 4, a decrease in efficiency of the first light and the second light can be prevented, the reliability of the optical element can be improved, and the optical element can be readily designed and manufactured.

(Additional Remark 5) The optical element according to Additional Remark 3, wherein the first and second dielectric multilayer films each include any one of an oxide, a nitride, and a fluoride.

The configuration described in Additional Remark 5 allows increases in the reliability and durability of the first and second optical thin films for excellent optical characteristics thereof.

(Additional Remark 6) The optical element according to any one of Additional Remarks 1 to 5, wherein the second wavelength band is a near-infrared wavelength band.

The configuration described in Additional Remark 6 allows widening the range over which the material of each of the first and second optical thin films is selected, so that the optical element can be readily manufactured. The configuration described in Additional Remark 6 can further reduce the difference in wavelength between the near-infrared wavelength band and the first wavelength band to suppress the influence on the transmittance of the optical element for the first light and the second light traveling along the optical paths thereof and the amounts of the first light and the second light emitted from the optical element.

(Additional Remark 7) The optical element according to any one of Additional Remarks 1 to 6, wherein the transmittance of the second optical thin film for at least one of the S-polarized light and the P-polarized light of the second light increases as the angle of incidence of the at least one polarized light incident on the second optical thin film increases.

The configuration described in Additional Remark 7 can suppress a decrease in efficiency of the first light and the second light in the optical element.

(Additional Remark 8) The optical element according to any one of Additional Remarks 1 to 7, wherein the first wavelength band is a green wavelength band, and the third wavelength band is a blue wavelength band.

The configuration described in Additional Remark 8 can readily separate the green light having the green wavelength band and the blue light having the blue wavelength band from each other so as to travel along different optical paths.

(Additional Remark 9) An optical instrument including the optical element according to Additional Remark 1 or 2, wherein the second light is incident on the second optical thin film in such a way that an intensity of the S-polarized light of the second light emitted from the second optical thin film is substantially equal to an intensity of the P-polarized light of the second light.

The configuration described in Additional Remark 8 can suppress the difference in the polarization characteristics between the multiple types of the radiation light emitted from the optical instrument to reduce illuminance unevenness.

(Additional Remark 10) The optical instrument according to Additional Remark 9, wherein the angle of incidence of each of the first light and the second light is 45°.

The configuration described in Additional Remark 10 can simplify the arrangement of the elements of the optical instrument.

(Additional Remark 11) The optical instrument according to Additional Remark 9 or 10, wherein the second light is randomly polarized light.

In the configuration described in Additional Remark 11, an LED is used as a light emitter of a light source apparatus that emits the second light, so that the size and the cost of the optical instrument can be reduced.

(Additional Remark 12) The optical instrument according to Additional Remark 9 or 10, wherein the first light is linearly polarized light incident as the S-polarized light on the first optical thin film.

The configuration described in Additional Remark 12 allows the first light to be efficiently emit to an element downstream from the optical element, so that the first light can be used at increased efficiency.

(Additional Remark 13) The optical instrument according to any one of Additional Remarks 9 to 12, further including a light modulator configured to receive light emitted from the optical element, and modulate light having the visible wavelength band out of the incident light in accordance with image information.

According to the configuration described in Additional Remark 13, the first light emitted from the optical element can be modulated into image light, which is enlarged and projected, and the second light can be enlarged and projected in a predetermined pattern without being modulated by the light modulator.

(Additional Remark 14) A projector including the optical element according to any one of Additional Remarks 1 to 8.

The configuration described in Additional Remark 14 can suppress a difference in polarization characteristics between the image light including the first light and the second light emitted from the optical element to reduce illuminance unevenness in the projected image and the patterned second light.

(Additional Remark 15) A projector including the optical instrument according to any one of Additional Remarks 9 to 13.

The configuration described in Additional Remark 15 can suppress the difference in polarization characteristics between the image light including the first light and the second light emitted from the optical element to reduce the illuminance unevenness in the projected image and the patterned second light.

What is claimed is:

1. An optical element comprising:
a light transmissive substrate having a first surface and a second surface opposite the first surface;
a first optical thin film provided on the first surface, configured to reflect first light having a first wavelength band out of a visible wavelength band, and configured to transmit infrared light having an infrared wavelength band; and
a second optical thin film provided on the second surface and configured to transmit second light having a second wavelength band out of the infrared wavelength band,
wherein transmittance of the first optical thin film for the infrared light incident thereon at an angle of incidence greater than or equal to 30° but smaller than or equal to 60° is 90% or higher, and
out of S-polarized light and P-polarized light of the second light, polarized light showing a larger difference between maximum transmittance and minimum transmittance when incident on the first optical thin film at the angle of incidence greater than or equal to 30° but smaller than or equal to 60° is defined as first polarized light, and a positive or negative sign of a gradient of a curve indicating dependence of transmittance of the first optical thin film for first polarized light of the second light is opposite a positive or negative sign of a gradient of a curve indicating dependence of transmittance of the second optical thin film for the first polarized light of the second light.

2. The optical element according to claim 1, wherein
the first optical thin film is configured to transmit third light having a third wavelength band out of the visible wavelength band that differs from the first wavelength band, and
the second optical thin film is configured to transmit the third light.

3. The optical element according to claim 1, wherein
the first optical thin film is configured with a first dielectric multilayer film in which first high-refractive-index layers and first low-refractive-index layers are alternately layered on each other, and
the second optical thin film is configured with a second dielectric multilayer film in which second high-refractive-index layers and second low-refractive-index layers are alternately layered on each other.

4. The optical element according to claim 3, wherein
the number of the first high-refractive-index layers, the number of the first low-refractive-index layers, and a difference in refractive index between the first high-refractive-index layers and the first low-refractive-index layers are determined in accordance with the dependence of the transmittance of the first optical thin film for the first polarized light of the first light on the angle of incidence, and
the number of the second high-refractive-index layers, the number of the second low-refractive-index layers, and a difference in refractive index between the second layers high-refractive-index and the second low-refractive-index layers are determined in accordance with the positive or negative sign of the gradient of the curve indicating the dependence of the transmittance of the first optical thin film for the first polarized light of the second light on the angle of incidence.

5. The optical element according to claim 3, wherein
the first and second dielectric multilayer films each include any one of an oxide, a nitride, and a fluoride.

6. The optical element according to claim 1, wherein
the second wavelength band is a near-infrared wavelength band.

7. The optical element according to claim 1, wherein
the transmittance of the second optical thin film for at least one of the S-polarized light and the P-polarized light of the second light increases as the angle of incidence of the at least one polarized light incident on the second optical thin film increases.

8. The optical element according to claim 2, wherein
the first wavelength band is a green wavelength band, and
the third wavelength band is a blue wavelength band.

9. An optical instrument comprising
the optical element according to claim 1,
wherein the second light is incident on the second optical thin film in such a way that an intensity of the S-polarized light of the second light emitted from the second optical thin film is substantially equal to an intensity of the P-polarized light of the second light.

10. The optical instrument according to claim 9, wherein
the angle of incidence of each of the first light and the second light is 45°.

11. The optical instrument according to claim 9, wherein
the second light is randomly polarized light.

12. The optical instrument according to claim 9, wherein
the first light is linearly polarized light incident as the S-polarized light on the first optical thin film.

13. The optical instrument according to claim 9, further comprising
a light modulator configured to receive light emitted from the optical element, and modulate light having the visible wavelength band out of the incident light in accordance with image information.

14. A projector comprising
the optical element according to claim 1.

15. A projector comprising
the optical instrument according to claim 9.
